(19) United States
(12) Patent Application Publication
(10) Pub. No.: US 2015/0149639 A1
(43) Pub. Date: May 28, 2015

(54) BANDWIDTH ALLOCATION IN A NETWORKED ENVIRONMENT

(71) Applicants: Abdul Hawk Ismail, Beaverton, OR (US); Sean Stalley, Hillsboro, OR (US); John Howard, Hillsboro, OR (US)

(72) Inventors: Abdul Hawk Ismail, Beaverton, OR (US); Sean Stalley, Hillsboro, OR (US); John Howard, Hillsboro, OR (US)

(21) Appl. No.: 14/333,338

(22) Filed: Jul. 16, 2014

Related U.S. Application Data
(60) Provisional application No. 61/907,688, filed on Nov. 22, 2013.

(51) Int. Cl. H04L 12/911; H04L 29/08

(52) U.S. Cl. CPC H04L 47/70; H04L 67/02
USPC 709/226

(57) ABSTRACT

Techniques for allocating bandwidth in a networked environment are described herein. A hub may include logic, at least partially comprising hardware logic. The logic is configured to receive data flow including packets at the hub. The logic is further configured to assign a weight to the packets based on the speed of the data flow, and allocate bandwidth of an upstream link based on the weight assigned to the packets.

### CROSS REFERENCE TO RELATED APPLICATIONS

The present application claims priority to U.S. Provisional Patent Application No. 61/907,688, filed Nov. 22, 2013, which is incorporated herein by reference.

### TECHNICAL FIELD

This disclosure relates generally to techniques for improving the communication speeds of multiple clients on a network with a central host. More specifically, the disclosure describes techniques for allocating bandwidth in a networked environment.

### BACKGROUND

As devices and components become more complex and undertake heavier workloads, performance has become an increasing concern. Part of the computer performance rests in available data transfer speeds. Transfer speeds can vary for a variety of reasons, from the hardware used, to whether a networked system of computers is configured to send data to a central source at or near the same time. Networked computer systems include a number of components and elements. Often the components and even separate computers are coupled via a bus or some form of interconnect.

In a network where multiple clients need to send data to a central host and those clients share one or more network links, it can become difficult to ensure that each client's data flow receives a fair portion of the available bandwidth on the network. For example, Universal Serial Bus (USB) 3.0 “SuperSpeed USB” limited the number of simultaneous, active clients over network so that only one client was sending data to the host at a time. In addition, allowing only one client to send data at a time leads to wasted time on the network while the host determines the next client to activate.

### BRIEF DESCRIPTION OF DRAWINGS

FIG. 1 is a block diagram of a hub having an allocation engine;

FIG. 2 is a diagram illustrating multiple clients configured to communicate with a central host through one or more hubs in a networked environment;

FIG. 3 is a diagram illustrating a hub configured to allocate bandwidth between client computers sending data flows to a central host computer;

FIG. 4 is a diagram illustrating a networked environment wherein weights are assigned as data flows are added to the networked environment;

FIG. 5 is a block diagram illustrating a method for allocating bandwidth; and

FIG. 6 is a block diagram depicting an example of a computer-readable medium configured to allocate bandwidth.

### DETAILED DESCRIPTION

The subject matter described herein relates to techniques for initiating data flows at one or more hubs in a networked environment. A dataflow, as referred to herein, is a stream of data packets. The hub assigns weights to data flows based on the speed of each data flow. The hub allocates upstream bandwidth based on the weight of each data flow received. The hub may combine upstream data flows and assign combined data flows weights based on the combined weight of each data flow in the combined data flow. In this manner, the hub may transmit multiple data flows simultaneously to upstream components, such as another hub, a host computer, and the like.

In aspects, the techniques described herein may be implemented in Universal Serial Bus (USB) protocol hubs. In USB 3.1 released Jul. 26, 2013, data flows may be propagated at a “SuperSpeed” of about 5 gigabytes per second (GBps) or at a “SuperSpeedPlus” of about 10 GBps. The speed may be indicated in a field of a packet within each data flow. As stated above, the hub assigns weight to a data flow based on the speed indication.

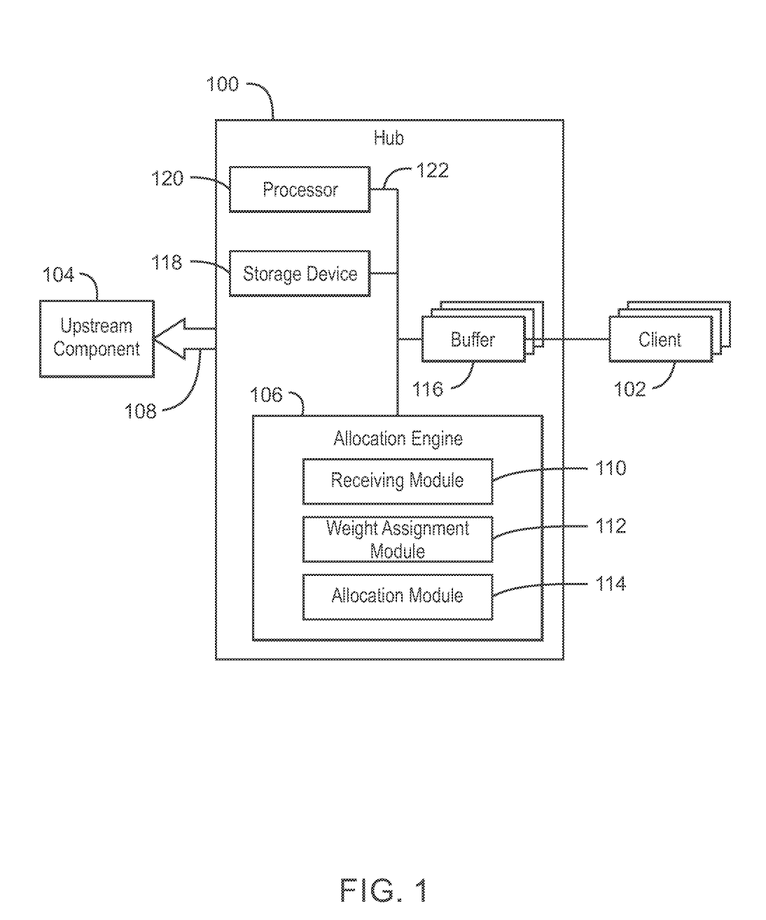

FIG. 1 is a block diagram of a hub having an allocation engine. The hub 100 may be a component in a networked environment. As illustrated in FIG. 1, the hub 100 may be communicatively coupled to one or more downstream client devices 102 and an upstream component 104.

The hub includes an allocation engine 106 configured to allocate upstream bandwidth indicated at 108. The allocation engine 106 may include a receiving module 110, a weight assignment module 112, and an allocation module 114. The receiving module 110 may be configured to receive a data flow comprising packets at the hub 100 from one or more of the client devices 102. A data flow comprises packets from any one of the client devices 102. Each data flow may be received at a buffer 116. In embodiments, one buffer is assigned to each client device 102. The receiving module 110 may identify a speed at which the packets were received in each data flow from the client devices 102. The weight assignment module 112 assigns a weight to the packets based on the speed of the data flow. The allocation module 114 allocates bandwidth of the upstream link 108 based on the weight assigned to the packets.

In some cases, the allocation engine 106 may be implemented as logic, at least partially including hardware logic, such as electrical circuits configured to determine the speed of incoming packets. The allocation engine 106 may, in some cases, be implemented as instructions stored on a storage device 118, and executable by a processor 120. In yet other examples, the allocation engine 106 may be a combination of hardware, software, and firmware.

The modules 110, 112, 114 may be configured to operate independently, in parallel, distributed, or as a part of a broader process. In any case, the modules 120, 122, 124 are configured to carry out operations for bandwidth allocation as described above, and as described further below.

The processor 102 may be a main processor that is adapted to execute the stored instructions. The processor 102 may be a single core processor, a multi-core processor, a computing cluster, or any number of other configurations. The processor 102 may be implemented as Complex Instruction Set Computer (CISC) or Reduced Instruction Set Computer (RISC) processors, x86 Instruction set compatible processors, multi-core, or any other microprocessor or central processing unit (CPU).

The buffers 116 can include random access memory (RAM) (e.g., static random access memory (SRAM), dynamic random access memory (DRAM), zero capacitor RAM, Silicon-Oxide-Nitride-Oxide-Silicon SONOS, embedded DRAM, extended data out RAM, double data rate (DDR) RAM, resistive random access memory (RRAM), parameter random access memory (PRAM), etc.), read only memory (ROM) (e.g., Mask ROM, programmable read only memory (PROM), erasable programmable read only memory (EPROM), electrically erasable programmable read only memory (EEPROM), etc.), flash memory, or any other suitable memory systems. The processor 120 may be connected through a system bus 122 (e.g., Peripheral Component Interconnect (PCI), Industry Standard Architecture (ISA), PCI-Express, HyperTransport®, NuBus, etc.) to components including the buffers 116, the storage device 118, and the allocation engine 106.

The block diagram of FIG. 1 is not intended to indicate that the hub 100 is to include all of the components shown in FIG. 1. Further, the hub 100 may include any number of additional components not shown in FIG. 1, depending on the details of the specific implementation.

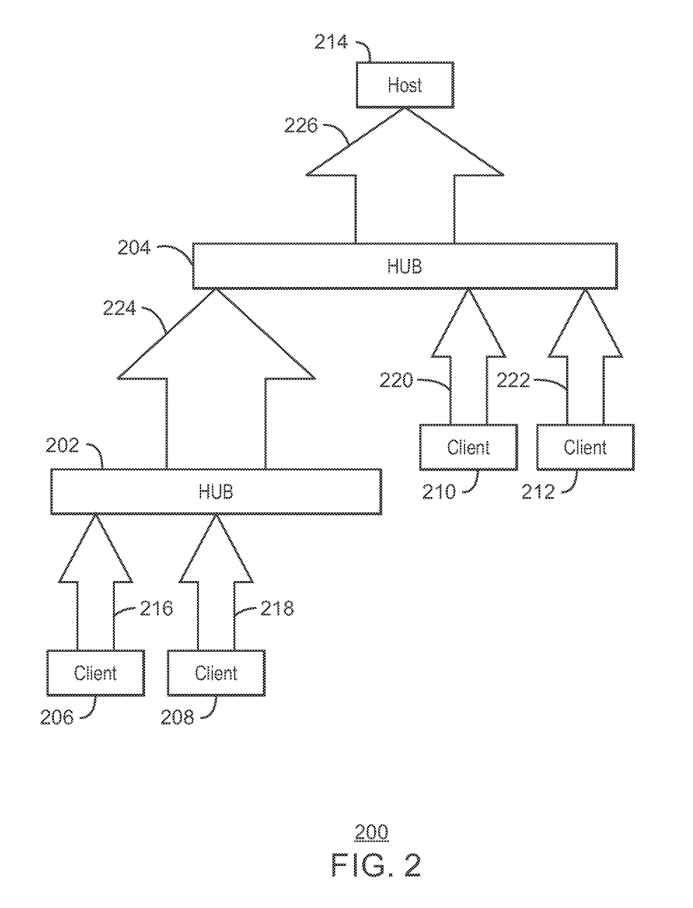

FIG. 2 is a diagram illustrating multiple clients configured to communicate with a central host through one or more hubs in a networked environment. The networked environment 200 includes a first hub 202 and a second hub 204. The hubs 202, 204, may include an allocation engine, such as the allocation engine 106 discussed above in regard to hub 100 of FIG. 1. As illustrated in FIG. 2, the hubs 202, 204 may be communicatively coupled to one or more client devices 206, 208, 210, and 212. Ultimately the data flows are provided upstream to a host computing device 214. The host computing device 214 may be a central computing device, such as a server, a personal computer, a laptop, a mobile computing device, and the like. The client devices 206, 208, 210, 212 may be peripheral devices such as smart phones, tablet computers, external storage devices, cameras, and the like configured to communicate with the host computing device 214.

The client devices 206, 208, 210, and 212 may each have a data flow provided to the respective hubs 202 and 204, as indicated at 216, 218, 220, and 222, respectively. For example, the hub 202 may receive a first data flow 216 from the client 206, and a second data flow 218 from client 208. The first hub 202 assigns weights to packets of each of the data flows 216 and 218 based on a speed associated with the data flows 216 and 218. The speed may be indicated in a field of a packet received at the hub 202 as each data flow 216 and 218 is received. Based on the weights assigned to each data flow 216 and 218, the hub 202 assigns a weight to a combined data flow 224 provided upstream to the second hub 204.

For example, the data flow 216 may have a speed of 5 GBps, and, therefore, may be assigned a weight of “1.” The data flow 218 may have a speed of 10 GBps, and may be assigned a weight of “2.” The combined data flow 224 may have a weight of “3” as the weight of the combined data flow 224 is the sum of the weights assigned to the data flows 216 and 218, respectively. The bandwidth allocation at the upstream data flow 224 is based on the individual weights of each data flow 216 and 218. In this example, one third of the bandwidth will be allocated to data flow 216 and two thirds of the bandwidth will be allocated to data flow 218.

As illustrated in FIG. 2, the second hub 204 receives the combined data flow 224 as well as data flows 220 and 222 from client devices 210 and 212, respectively. The allocation of bandwidth by the second hub 204 is dependent on the weight of each data flow 220, 222, and 224. For example, if the combined data flow 224 has a weight of “3,” and each of the data flows 220 and 222 are assigned a weight of “1,” the combined data flow 224 will be allocated three fifths of any upstream bandwidth. Similar to the first hub 202, the second hub 204 provides a combined data flow 226 to the host 214. Continuing in the example above, the combined data flow 226 will have a weight of “5.”

In the networked environment 200, a hub may be associated with a tier level. In techniques described above, bandwidth may be shared for simultaneous transmission of packets from different client devices, regardless of tier level. For example, no matter how many hubs are between a client device and the host 214, a given data flow may preserve a fair share of bandwidth as it progresses through the networked environment 200 towards the host 214. In other words, independent data flows from client devices connected at different tiers in the networked environment 200 will be provided the same bandwidth service on shared upstream links as if each of the client devices were connected at the same tier level sharing the same upstream link to the host 214.

Note that the networked environment 200 of FIG. 2 is for exemplary purposes only, and the techniques described herein are not limited to the use of a specific number of hubs, client devices, and the like, when allocating bandwidth. Any number of hubs might be implemented, and may be situated at any available tier.

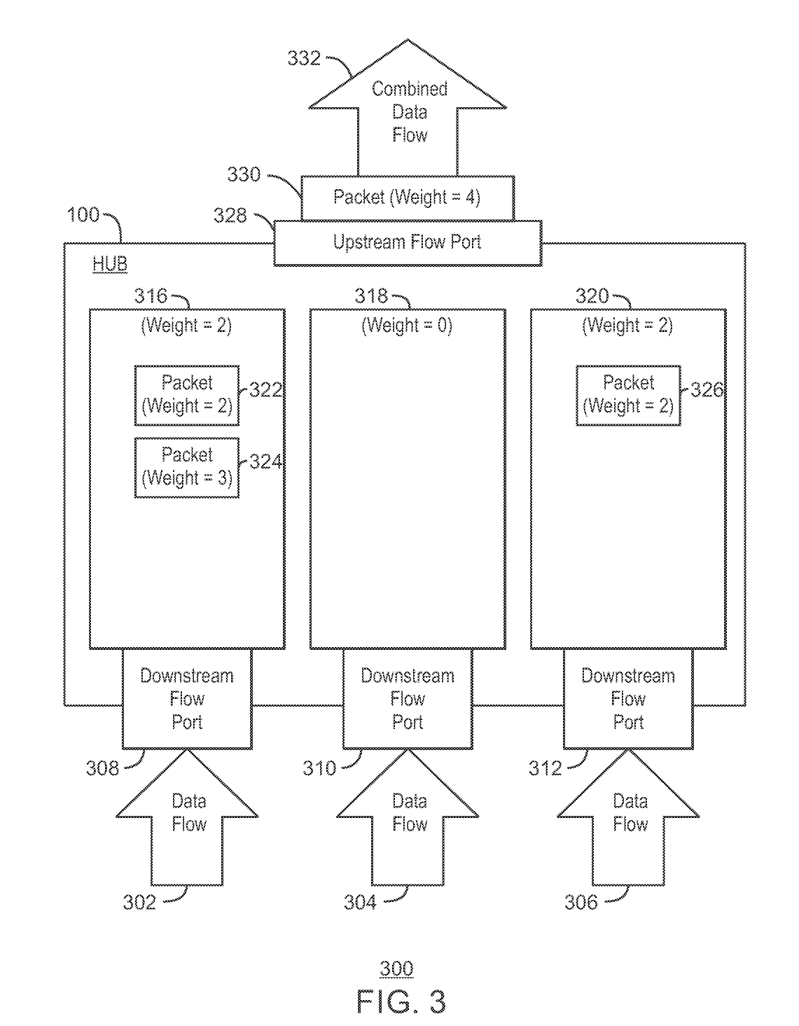

FIG. 3 is a diagram illustrating a hub configured to allocate bandwidth between client computers sending data flows to a central host computer. Data flows 302, 304, 306, may be received at a hub, such as the hub 100 discussed above in reference to FIG. 1. The data flows 302, 304, 306 may be asynchronous (time-insensitive) client data flows. The data flows 302, 304, 306 are received at downstream ports 308, 310, and 312, respectively. As discussed above, the hub 100 may include buffers. In FIG. 3, the buffers are numbered 316, 318, and 320. Each of the buffers 316, 318, and 320, are associated with an individual data flow. For example, data flow 302 is received at buffer 316, data flow 304 is received at buffer 318, and data flow 306 is received at buffer 320.

As discussed above, data flows are assigned a weight by the hub 100 based on the speed of each data flow 302, 304, and 306. As discussed above in reference to FIG. 1 and FIG. 2, packets associated with each data flow are assigned weights. For example, in FIG. 3, data flow 302 includes two packets, packet 322 and packet 324. In this example, packet 322 was received before packet 324, and therefore, packet 322 will be assigned a weight before packet 324. The weight associated with buffer 316 is equal to the weight of packet 322. In buffer 318, there are no packets, and the weight associated with the buffer 318 is zero. In buffer 320, the weight is equal to the weight of packet 326. The packets 322 and 326 at the head of buffers 316 and 320, respectively, are provided to an upstream flow port 328. Sum of the weight of the packets 322 and 326, is “4”, as indicated at 330. Therefore, the combined data flow 332 has a weight of “4.” As discussed above in regard to FIG. 2, the weight of the combined data flow 332 will be received by any upstream components, such as the second hub 204 of FIG. 2.

In embodiments, the weighting process described above is a weighted round-robin algorithm used only on asynchronous data, or data that is not time sensitive. In some scenarios, a credit system is implemented by the hub 100, to limit the incoming data flows 302, 304, 306. Credits represent available buffer space for incoming packets. Credits are spent when the client transmits a packet. Credits are returned by the hub 100 when a packet is forwarded upstream and buffer space becomes available. Packets are only forwarded to the hub 100 if the client has enough credits.

It is to be understood that the schematic of FIG. 3 is not intended to indicate that the hub 100 is to include all of the components shown in FIG. 3. Rather, the hub 100 can include fewer or additional components not illustrated in FIG. 3.

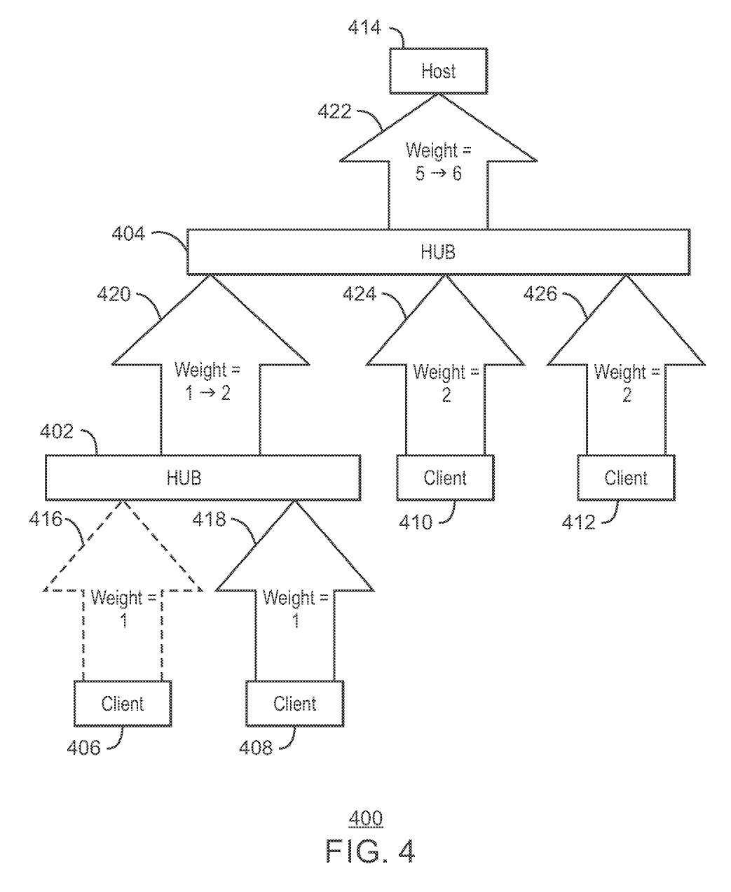

FIG. 4 is a diagram illustrating a networked environment wherein weights are assigned as data flows are added to the networked environment. Similar to the networked environment 200 of FIG. 2, the networked environment 400 includes a first hub 402 and a second hub 404. The hubs 402 and 404 include an allocation engine, such as the allocation engine 106 discussed above in regard to FIG. 1. As illustrated in FIG. 4, the first hub 402 and the second hub 404 communicatively couple client devices 406, 408, 410, and 412 to a host device 414.

In the example illustrated in FIG. 4, a client device 406 is added to the networked environment 400, as illustrated by the dashed arrow 416. The allocation engine 106 of the hubs 402 and 404 may compensate for added data flows on the fly. As the data flow from client 406 is added, upstream weights are recalculated, and bandwidth allocation is redistributed. For example, the weight of the added data flow 416 is “1,” while the weight of a pre-existing data flow 418 is also “1.” As indicated at 410, the weight of the combined data flow is modified from a weight of “1” to a weight of “2.” Any upstream hubs may also recalculate combined data flow weights. For example, the second hub 404 recalculates the weight of a combined data flow 422 from “5” to “6” based on the data flows 424 and 426, as well as the modified weight of the combined data flow 420.

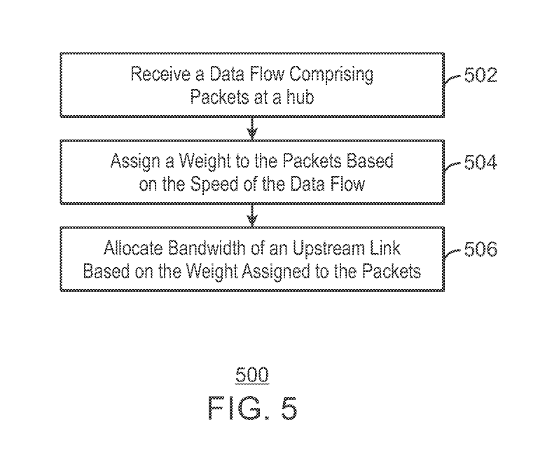

FIG. 5 is a block diagram illustrating a method for allocating bandwidth. At block 502, data flow is received including packets at a hub. A weight is assigned to the packets based on the speed of the data flow at block 504. Bandwidth is allocated based on the weight assigned to the packets at 506.

For example, the weight may be assigned, at block 504, to data flows of asynchronous data. The weight assignment may enable data flows from multiple client devices to be forwarded simultaneously through multiple tiers of a networked environment. In some scenarios, the data flow is a first data flow, and the method 500 may include receiving any number of additional data flows at the hub. Weight may be assigned to all of the data flows based on their respective speed. The first data flow and all other data flows may be combined into an upstream data flow. The weight of the upstream data flow is equal to the sum of the weight of all of the combined data flows.

As another example, the hub may be a first hub, and the method 500 includes receiving the combined data flow at a second hub from the first hub. The second hub may be configured to receive a third data flow including packets. A weight may be assigned to the packets of the third data flow based on a speed of the third data flow. As discussed above in regard to FIG. 2, the combined data flow from the first hub, and the third data flow may be combined into another combined data flow in the second hub to be provided upstream. The weight of the combined data flow is the sum of the weight of the combined data flow from the first hub and the weight of the third data flow.

The weight may indicate how much of the bandwidth is allocated to a given data flow. For example, a higher weight results in a higher bandwidth allocation for a given data flow in comparison to a lower weight. It may be important to note that, in some scenarios, the weights are assigned to asynchronous data flows in a USB networked environment. Further, the method 500 may include redistribution of bandwidth as one or more devices are connected, or begin transmitting data flows to the networked environment. In addition, redistribution may occur when a device is disconnected from the networked environment. Further, redistribution may be delayed until all of the packets received by the hub and associated with a disconnected device are forwarded upstream by the hub.

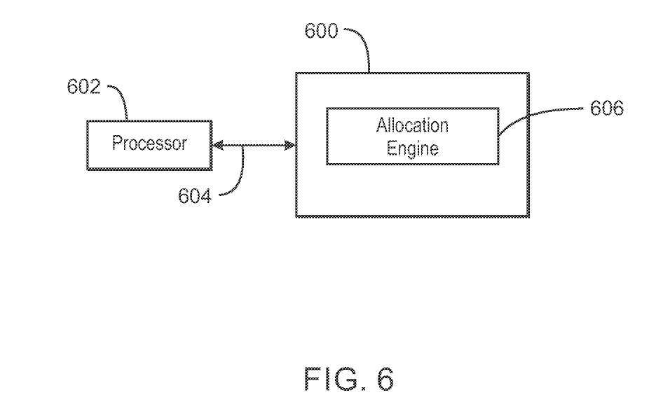

FIG. 6 is a block diagram depicting an example of a computer-readable medium configured to allocate bandwidth. The computer-readable medium 600 may be accessed by a processor 602 over a computer bus 604. In some examples, the computer-readable medium 600 may be a non-transitory computer-readable medium. In some examples, the computer-readable medium may be a storage medium, but not including carrier waves, signals, and the like. Furthermore, the computer-readable medium 600 may include computer-executable instructions to direct the processor 602 to perform the steps of the current method.

The various software components discussed herein may be stored on the tangible, non-transitory, computer-readable medium 600, as indicated in FIG. 6. For example, an allocation engine 606 may be configured to receive a data flow comprising packets at the hub, and assign a weight to the packets based on the speed of the data flow. Bandwidth is allocated by the allocation engine 606 based on the weight assigned to the packets.

Example 1 is an apparatus for bandwidth allocation in a networked environment. The apparatus includes a receiver to receive data flow comprising packets, a weight assignor to assign a weight to the packets based on the speed of the data flow, and an allocator to allocate bandwidth of an upstream link based on the weight assigned to the packets.

Example 2 incorporates the subject matter of Example 1. In this example, the receiver is configured to receive a second data flow, and the weight assignor is assign a weight to packets of the second data flow based on a speed of the second data flow. A combinor is further configured to combine the first data flow and the second data flow into a combined upstream data flow, wherein the weight of the upstream dataflow is equal to the sum of the weight of the first data flow and the weight of the second data flow. A combinor, in some scenarios, may be a module, logic, or any other programmable mechanism.

Example 3 incorporates the subject matter of any combination of Examples 1-2. In this example, the receiver is to receive the combined data flow from a first hub, and receive a third data flow including packets at a second hub. The weight assignor is further configured to assign a weight to packets of the third data flow based on a speed of the third data flow. The combinor also configured to combine the combined dataflow and the third data flow into a combined upstream data flow, wherein the weight of the upstream data flow from the second hub is equal to the sum of the combined weight of the data flow from the first hub and the weight of the second data flow.

Example 4 incorporates the subject matter of any combination of Examples 1-3. In this example, the data flow comprises asynchronous data in an Universal Serial Bus networked environment.

Example 5 incorporates the subject matter of any combination of Examples 1-4. In this example, a higher weight assignment indicates a greater amount of upstream bandwidth allocated in comparison to a lower weight assignment.

Example 6 incorporates the subject matter of any combination of Examples 1-5. In this example, the allocator is to redistribute bandwidth as one or more devices having data flows are connected to the apparatus.

Example 7 incorporates the subject matter of any combination of Examples 1-6. In this example, the allocator is to delay redistribution when one or more devices having data flows are disconnected from the apparatus until all packets received by the apparatus and associated with the disconnected device are forwarded upstream by the apparatus.

Example 8 incorporates the subject matter of any combination of Examples 1-7. In this example, the apparatus is a downstream hub, and the allocation of bandwidth to the upstream link is provided from the downstream hub to an upstream hub.

Example 9 incorporates the subject matter of any combination of Examples 1-8. In this example, the apparatus is an upstream hub, and the logic is further configured to receive weighted packets from a downstream hub

Example 10 incorporates the subject matter of any combination of Examples 1-9. In this example, the weight of the packets is preserved on the upstream link.

Example 11 is a method for bandwidth allocation in a networked environment. The method includes receiving a data flow comprising packets at the hub. The method includes assigning a weight to the packets based on the speed of the data flow, and allocating bandwidth of an upstream link based on the weight assigned to the packets.

Example 12 incorporates the subject matter of Example 11. In this example, the method includes receiving a second data flow at the hub, and assigning a weight to packets of the second data flow based on a speed of the second data flow. The method further includes combining the first data flow and the second data flow into a combined upstream data flow, wherein the weight of the upstream dataflow is equal to the sum of the weight of the first data flow and the weight of the second data flow.

Example 13 incorporates the subject matter of any combination of Examples 11-12. In this example, the hub is a first hub and method includes receiving the combined data flow from the first hub, and receiving a third data flow including packets at a second hub. The method further includes assigning a weight to packets of the third data flow based on a speed of the third data flow. The method also includes combining the combined dataflow and the third data flow into a combined upstream data flow, wherein the weight of the upstream data flow from the second hub is equal to the sum of the combined weight of the data flow from the first hub and the weight of the second data flow.

Example 14 incorporates the subject matter of any combination of Examples 11-13. In this example, the data flow comprises asynchronous data in an Universal Serial Bus networked environment.

Example 15 incorporates the subject matter of any combination of Examples 11-14. In this example, a higher weight assignment indicates a greater amount of upstream bandwidth allocated in comparison to a lower weight assignment.

Example 16 incorporates the subject matter of any combination of Examples 11-15. In this example, the method further includes redistributing bandwidth as one or more devices having data flows are connected to the hub.

Example 17 incorporates the subject matter of any combination of Examples 11-16. In this example, the includes delaying redistribution when one or more devices having data flows are disconnected from the hub until all packets received by the hub and associated with the disconnected device are forwarded upstream by the hub.

Example 18 incorporates the subject matter of any combination of Examples 11-17. In this example, the hub is a downstream hub, and the allocation of bandwidth to the upstream link is provided from the downstream hub to an upstream hub.

Example 19 incorporates the subject matter of any combination of Examples 11-18. In this example, the hub is an upstream hub, and further includes receiving weighted packets from a downstream hub

Example 20 incorporates the subject matter of any combination of Examples 11-19. In this example, the weight of the packets is preserved on the upstream link.

Example 21 is a computer-readable medium. The computer-readable medium may be a non-transitory computer-readable medium. The computer-readable medium may include code, when executed, cause a processing device to perform the method of any combination of Examples 11-20.

Example 22 is a system for bandwidth allocation in a networked environment. The system includes a downstream hub having logic, at least partially including hardware logic. The logic of the downstream hub is configured to receive a data flow comprising packets at the downstream hub, and assign a weight to the packets based on the speed of the data flow. The logic of the downstream hub is further configured to allocate bandwidth of an upstream link based on the weight assigned to the packets. The system further includes an upstream hub. The upstream hub includes logic, at least partially including hardware logic. The logic of the upstream hub is configured to receive the data flow from the downstream up, and identify the assigned weight of the data flow from the downstream hub. The logic of the upstream hub is further configured to combine the data flow from the downstream hub with any additional data flow received at the upstream hub.

Example 23 incorporates the subject matter of Example 22. In this example, the data flow at the downstream hub is a first data flow, and the logic of the downstream hub is to receive a second data flow at the downstream hub. The logic of the downstream hub is further configured to assign a weight to packets of the second data flow at the downstream hub based on a speed of the second data flow, and combine the first data flow and the second data flow into a combined upstream data flow, wherein the weight of the upstream dataflow is equal to the sum of the weight of the first data flow and the weight of the second data flow.

Example 24 incorporates the subject matter of any combination of Example 22-23. In this example, the logic of the upstream hub is to receive a third data flow comprising packets at the upstream hub, and assign a weight to packets of the third data flow based on a speed of the third data flow. The logic of the upstream hub is further configured to combine the dataflow combined at the downstream hub and the third data flow into a new combined upstream data flow at the upstream hub, wherein the weight of the new upstream data flow from the upstream hub is equal to the sum of the combined weight of the data flow combined at the first hub and the weight of the third data flow.

Example 25 incorporates the subject matter of any combination of Example 22-23. In this example, the data flow comprises asynchronous data in an Universal Serial Bus networked environment.

Example 26 incorporates the subject matter of any combination of Example 22-25. In this example, a higher weight assignment indicates a greater amount of upstream bandwidth allocated in comparison to a lower weight assignment.

Example 27 incorporates the subject matter of any combination of Example 22-26. In this example, the logic of the upstream hub is to redistribute bandwidth as one or more devices having data flows are connected to the upstream hub.

Example 28 incorporates the subject matter of any combination of Example 22-27. In this example, the logic of the upstream hub is to delay redistribution when one or more devices having data flows are disconnected from the upstream hub until all packets received by the upstream hub and associated with the disconnected device are forwarded upstream by the upstream hub.

Example 29 incorporates the subject matter of any combination of Example 22-28. In this example, the logic of the downstream hub is to redistribute bandwidth as one or more devices having data flows are connected to the downstream hub.

Example 30 incorporates the subject matter of any combination of Example 22-29. In this example, the logic of the downstream hub is to delay redistribution when one or more devices having data flows are disconnected from the downstream hub until all packets received by the downstream hub and associated with the disconnected device are forwarded upstream by the downstream hub.

Example 31 is an apparatus for bandwidth allocation in a networked environment. The apparatus includes a means to receive a data flow comprising packets at the hub, and a means to assign a weight to the packets based on the speed of the data flow. The apparatus further includes a means to allocate bandwidth of an upstream link based on the weight assigned to the packets.

Example 32 incorporates the subject matter of Example 31. In this example the data flow is a first data flow. The apparatus further includes a means to receive a second data flow at the hub, assign a weight to packets of the second data flow based on a speed of the second data flow, and combine the first data flow and the second data flow into a combined upstream data flow, wherein the weight of the upstream dataflow is equal to the sum of the weight of the first data flow and the weight of the second data flow.

Example 33 incorporates the subject matter of any combination of Examples 31-32. In this example, the hub is a first hub. The apparatus further includes a means to receive the combined data flow from the first hub, receive a third data flow comprising packets at a second hub, and assign a weight to packets of the third data flow based on a speed of the third data flow. The means may be further configured to combine the combined dataflow and the third data flow into a combined upstream data flow, wherein the weight of the upstream data flow from the second hub is equal to the sum of the combined weight of the data flow from the first hub and the weight of the second data flow.

Example 34 incorporates the subject matter of any combination of Examples 31-33. In this example the data flow comprises asynchronous data in an Universal Serial Bus networked environment.

Example 35 incorporates the subject matter of any combination of Examples 31-34. In this example a higher weight assignment indicates a greater amount of upstream bandwidth allocated in comparison to a lower weight assignment.

Example 36 incorporates the subject matter of any combination of Examples 31-35. In this example, the apparatus further includes a means to redistribute bandwidth as one or more devices having data flows are connected to the hub.

Example 37 incorporates the subject matter of any combination of Examples 31-36. In this example, the apparatus further includes a means to delay redistribution when one or more devices having data flows are disconnected from the hub until all packets received by the hub and associated with the disconnected device are forwarded upstream by the hub.

Example 38 incorporates the subject matter of any combination of Examples 31-37. In this example, the hub is a downstream hub, and wherein the allocation of bandwidth to the upstream link is provided from the downstream hub to an upstream hub.

Example 39 incorporates the subject matter of any combination of Examples 31-38. In this example, the hub is an upstream hub, and the apparatus further includes a means to receive weighted packets from a downstream hub.

Example 40 incorporates the subject matter of any combination of Examples 31-39. In this example, the weight of the packets is preserved on the upstream link.

Example 41 is a computer-readable medium. The computer-readable medium may be a non-transitory computer-readable medium. The computer-readable medium may include code, when executed, cause a processing device to receive a data flow comprising packets at the hub, assign a weight to the packets based on the speed of the data flow, and allocate bandwidth of an upstream link based on the weight assigned to the packets.

Example 42 incorporates the subject matter of Example 41. In this example, the data flow is a first data flow, and the code, when executed is to cause the processing device to receive a second data flow at the hub, assign a weight to packets of the second data flow based on a speed of the second data flow, and combine the first data flow and the second data flow into a combined upstream data flow, wherein the weight of the upstream dataflow is equal to the sum of the weight of the first data flow and the weight of the second data flow.

Example 43 incorporates the subject matter of any combination of Examples 41-42. In this example, the code, when executed is to cause the processing device to receive the combined data flow from the first hub, receive a third data flow comprising packets at a second hub, and assign a weight to packets of the third data flow based on a speed of the third data flow. The code, when executed is to further cause the processing device to combine the combined dataflow and the third data flow into a combined upstream data flow, wherein the weight of the upstream data flow from the second hub is equal to the sum of the combined weight of the data flow from the first hub and the weight of the second data flow.

Example 44 incorporates the subject matter of any combination of Examples 41-43. In this example, the data flow comprises asynchronous data.

Example 45 incorporates the subject matter of any combination of Examples 41-44. In this example, the code, when executed is to cause the processing device to redistribute bandwidth as one or more devices having data flows are connected to the hub.

Example 46 incorporates the subject matter of any combination of Examples 41-45. In this example, the code, when executed is to cause the processing device to delay redistribution when one or more devices having data flows are disconnected from the hub until all packets received by the hub and associated with the disconnected device are forwarded upstream by the hub.

Example 47 incorporates the subject matter of any combination of Examples 41-46. In this example, the hub is a downstream hub, and wherein the allocation of bandwidth to the upstream link is provided from the downstream hub to an upstream hub.

Example 48 incorporates the subject matter of any combination of Examples 41-47. In this example, the code, when executed is to cause the processing device to receive weighted packets from a downstream hub.

Example 49 incorporates the subject matter of any combination of Examples 41-48. In this example, the weight of the packets is preserved on the upstream link.

Example 50 incorporates the subject matter of any combination of Examples 41-49. In this example, the data flow comprises asynchronous data in an Universal Serial Bus networked environment.

As used herein, an embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the present techniques. The various appearances of “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

It is to be understood that specifics in the aforementioned examples may be used anywhere in one or more embodiments. For instance, all optional features of the computing device described above may also be implemented with respect to either of the methods or the computer-readable medium described herein. Furthermore, although flow diagrams and/or state diagrams may have been used herein to describe embodiments, the techniques are not limited to those diagrams or to corresponding descriptions herein. For example, flow need not move through each illustrated box or state or in exactly the same order as illustrated and described herein.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

What is claimed is:

1. An apparatus for bandwidth allocation in a networked environment, comprising:
a receiver to receive a data flow comprising packets;
a prioritizor to assign a weight to the packets based on the speed of the data flow; and
an allocator to allocate bandwidth of an upstream link based on the weight assigned to the packets.

2. The apparatus of claim 1, wherein the data flow is a first data flow, wherein the receiver is to receive a second data flow at the hub, and the weight assignor is to assign a weight to packets of the second data flow based on a speed of the second data flow, further comprising: a combinor to combine the first data flow and the second data flow into a combined upstream data flow, wherein the weight of the upstream dataflow is equal to the sum of the weight of the first data flow and the weight of the second data flow.

3. The apparatus of claim 1, wherein the assigned weight is preserved on an upstream link.

4. The apparatus of claim 1, wherein the data flow comprises asynchronous data in an Universal Serial Bus networked environment.

5. The apparatus of claim 1, wherein a higher weight assignment indicates a greater amount of upstream bandwidth allocated in comparison to a lower weight assignment.

6. The apparatus of claim 1, wherein the allocator is to redistribute bandwidth as one or more devices having data flows are connected to the apparatus.

7. The apparatus of claim 6, wherein the allocator is to delay redistribution when one or more devices having data flows are disconnected from the apparatus until all packets received by the apparatus and associated with the disconnected device are forwarded upstream by the apparatus.

8. A method for bandwidth allocation in a networked environment, comprising:
receiving a data flow comprising packets at a hub;
assigning a weight to the packets based on the speed of the data flow;
allocating bandwidth of an upstream link based on the weight assigned to the packets.

9. The method of claim 8, wherein the data flow is a first data flow, further comprising:
receiving a new data flow at the hub;
assigning a weight to packets of the new data flow based on a speed of the new data flow;
combining the first data flow and the new data flow into a combined upstream data flow, wherein the weight of the upstream dataflow is equal to the sum of the weight of the first data flow and the weight of the new data flow.

10. The method of claim 9, wherein the hub is a first hub, further comprising:
receiving the combined data flow at a second hub from the first hub;
receiving an additional data flow comprising packets at the second hub;
assigning a weight to packets of the additional data flow based on a speed of the additional data flow; and
combining the combined dataflow and the additional data flow into a combined upstream data flow, wherein the weight of the combined upstream data flow is equal to the sum of the combined weight of the data flow from the first hub and the weight of the second data flow.

11. The method of claim 8, wherein the data flow comprises asynchronous data.

12. The method of claim 8, wherein a higher weight assignment indicates a proportionally greater amount of upstream bandwidth will be allocated than a lower weight assignment.

13. The method of claim 8, further comprising redistributing bandwidth as one or more devices having data flows are connected to the hub.

14. The method of claim 13, wherein redistribution is delayed when one or more devices having data flows are disconnected from the hub until all packets received by the hub and associated with the disconnected device are forwarded upstream by the hub.

15. A computer readable medium including code, when executed, to cause a processing device to:
receive a data flow comprising packets at the hub;
assign a weight to the packets based on the speed of the data flow; and
allocate bandwidth of an upstream link based on the weight assigned to the packets.

16. The computer readable medium of claim 15, wherein the data flow is a first data flow, wherein the code, when executed is to cause the processing device to:
receive a second data flow at the hub;
assign a weight to packets of the second data flow based on a speed of the second data flow; and
combine the first data flow and the second data flow into a combined upstream data flow, wherein the weight of the upstream dataflow is equal to the sum of the weight of the first data flow and the weight of the second data flow.

17. The computer readable medium of claim 16, wherein the hub is a first hub, wherein the code, when executed is to cause the processing device to:
receive the combined data flow from the first hub;
receive a third data flow comprising packets at a second hub;
assign a weight to packets of the third data flow based on a speed of the third data flow; and
combine the combined dataflow and the third data flow into a combined upstream data flow, wherein the weight of the upstream data flow from the second hub is equal to the sum of the combined weight of the data flow from the first hub and the weight of the second data flow.

18. The computer readable medium of claim 15, wherein the data flow comprises asynchronous data.

19. The computer readable medium of claim 15, wherein the code, when executed is to cause the processing device to redistribute bandwidth as one or more devices having data flows are connected to the hub.

20. The computer readable medium of claim 19, wherein the code, when executed is to cause the processing device to delay redistribution when one or more devices having data flows are disconnected from the hub until all packets received by the hub and associated with the disconnected device are forwarded upstream by the hub.
